(19) United States
(12) Patent Application Publication
(10) Pub. No.: US 2005/0194712 A1
(43) Pub. Date: Sep. 8, 2005

(54) Method of producing a mold for producing a shaped layer

(76) Inventor: Robert J. Adams, Yipsilanti, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/795,471

(22) Filed: Mar. 8, 2004

(51) Int. Cl. B29C 33/40

(52) U.S. Cl. 264/219; 264/309; 264/310

(57) ABSTRACT

A method of producing a mold for producing a shaped layer by gun spraying is disclosed, the method is facilitated by mathematically distorting the shaped layer using computer aided design to facilitate gun spraying resulting in an improvement in the quality of the shaped layer and an optimization of the amount of spray material applied by the spray gun.

### FIELD OF THE INVENTION

The invention relates to a method of preparing a surface and more particularly to a method of producing a mold for producing a shaped layer by gun spraying facilitated by mathematically distorting the shaped layer using computer aided design to facilitate the gun spraying.

### BACKGROUND OF THE INVENTION

A shaped layer produced from plastic material has a number of uses and applications. A number of techniques are used for making the shaped layer. One such technique is heat shaping. In heat shaping, a thermoplastic material sheet is heated above its softening temperature and is distorted inside a mold. The mold used corresponds to a negative or positive impression of a desired pattern. The process may be applied using a vacuum action, mechanical means, or the like, for example. The heat-shaping process is limited to applications which involving non-complex forms and plastic materials with a relatively low softening point.

A second method is slush molding, which includes completely filling a cavity from a tray-like mold with a liquid or solid powdered plastic material. When the plastic material contacts the mold walls, the plastic material begins to form a film on the mold walls. The mold is then inverted to remove excess liquid plastic material. Once the film remaining in the mold has cooled, the film is stripped from the mold walls. Slush molding is a labor-intensive process which requires large amounts of energy and subjects the molds to undesirable heat impact, resulting in damage to the molds.

A third technique is gun spraying which includes spraying a liquid plastic material over a mold surface to form a solidified plastic film. Gun spraying eliminates some of the drawbacks of the other methods described. However, one limitation has been that the gun spraying can be used only when all the portions of the surface to be coated are easily accessible by the spray from the gun. Certain methods, such as turning a flexible mold inside out to make the inner surfaces more accessible, have been employed in an attempt to reduce of eliminate this limitation. Such a method is not generally suitable for flexible molds having a counter-taper, for example, where it becomes very difficult or impossible to return the mould to the original position. Additionally, repeated turning inside out wears out the flexible mold over time.

It would be desirable to develop a method of gun spraying, slush molding, or rotocasting facilitating the molding of complex shapes wherein production efficiency is maximized and production costs are minimized.

### SUMMARY OF THE INVENTION

Consistent and consonant with the present invention, a method of gun spraying, slush molding, or rotocasting facilitating the molding of complex shapes wherein production efficiency is maximized and production costs are minimized has surprisingly been discovered.

The method of gun spraying, slush molding, or rotocasting comprises the steps of: creating a model of a desired part, creating a model of a desired part, creating a mathematical model of the part representing the model, designing a first mold having a distorted surface using the mathematical model of the part, the distorted surface representing a visible surface of the part distorted to facilitate application of a plastic layer, designing a second mold having a non-distorted surface representing a desired final shape of the part, producing the first mold and the second mold, and producing the part using the first mold and the second mold.

### BRIEF DESCRIPTION OF THE DRAWINGS

The above, as well as other advantages of the present invention, will become readily apparent to those skilled in the art from reading the following detailed description of an embodiment of the invention when considered in the light of the attached drawings, in which:

FIG. 1 is a flow diagram illustrating the method of producing a mold for producing a shaped layer by gun spraying and other molding techniques according to the present invention; and

FIG. 2 is a flow diagram of illustrating a production process using the mold produced according to the method of FIG. 1.

### DESCRIPTION OF THE PREFERRED EMBODIMENT

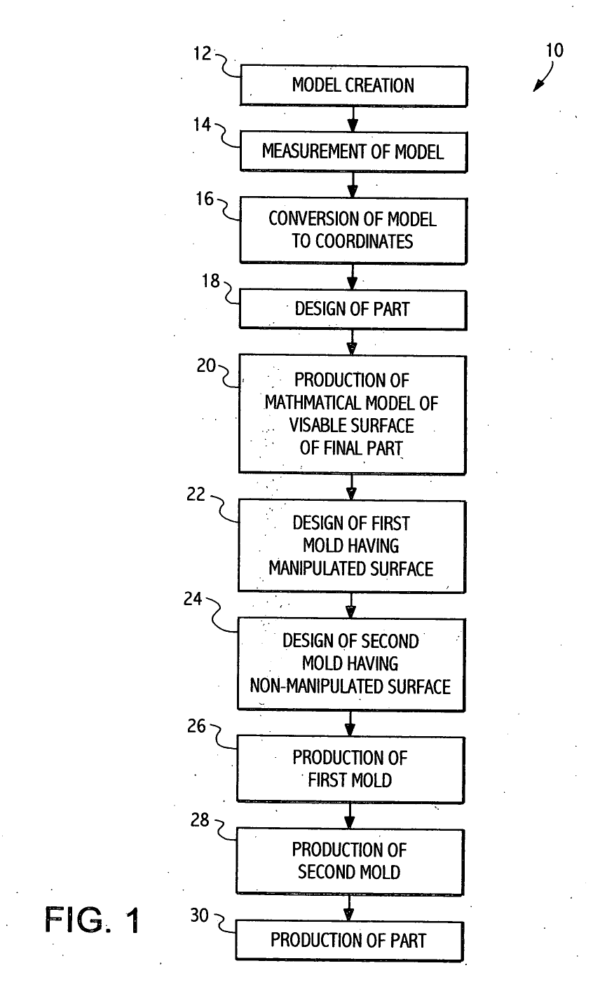

The invention relates to a method of preparing a shaped layer from a flexible plastic material from a particular pattern, shown generally at 10 in FIG. 1. The method of preparing a shaped layer 10 includes forming a layer of flexible plastic material on a shaping surface of a first mold which corresponds to a distorted pattern of a desired final shape. The distorted pattern of the final shape facilitates gun spraying, as well as other molding techniques, as surfaces of the final shape are visible on the surface of the distorted pattern. The layer of flexible plastic is then stripped from the first mold, and disposed on a second mold. A shaping surface of the second mold coincides with the desired final shape. The method of distorting the first mold by this invention is accomplished by the distorting of a mathematical or computer model which represents the final shape, rather than distorting an actual physical model or pattern of the final shape.

The method for producing a shaped layer 10 includes a first step of creating a model 12 of the desired final shape of a part. Typically, the model is created from clay to provide a representation of the desired final shape which is accurate in both shape and dimension. However, it is understood that other methods of creating the model 12 can be used such as creating a model on a computer, for example, without departing from the scope and spirit of the invention.

The second step involves taking dimensional measurements of the model 14. The measurements of the model 14 can be taken either manually or electronically, and recorded such as into a computer or to paper, for example. In the case of a computer generated model, this step can be eliminated.

Once recorded, the measurements of the model 14 are converted to mathematical coordinates 16, which are used to represent the model in space. In the preferred embodiment, the coordinates are converted using a CAD system, although other methods may be used such as manually drawing the model using the measurements, for example. The resulting representation is a replica of the model of the desired final shape.

The fourth step in the method is to design a part 18 based on the desired final shape using the mathematical coordinates obtained in the previous step. Typically, the part will include a flexible plastic layer, a rigid substrate or reinforcement, and a flexible foam or pad filler, for example.

Next, a mathematical model of a visible surface of the part is produced 20. This is accomplished by using the CAD system to illustrate the visible surface, the substrate, and the filler as an entity in three dimensions.

The sixth step involves using the mathematical model of the previous step to design a first mold having a manipulated or distorted surface 22. The distorted surface of this step represents the visible surface of the part distorted to facilitate molding of a flexible plastic layer thereupon. In essence, surfaces which may be difficult to reach using conventional molding techniques are distorted or manipulated, which may include inverting or angling the surface, for example, to make the surface more visible and accessible. In the preferred embodiment, the first mold surface is developed using a CAD system, however, it is understood that the conversion could also be accomplished manually. The use of the computer simply facilitates a more efficient process. The specific manipulation or distortion of the visible surface of the part depends upon the exact geometry of the final part. The method of manipulation involves revising an angle of intersecting surfaces, while maintaining the remaining geometry of the original configuration of the part. By using the computer, numerous distorted models can be examined and attempted in order to reach a nominal design for the mold. Previous methods have required that a physical model of the part is made, and the physical model of the part distorted manually in an attempt to determine a manipulated surface, which is time consuming, difficult, and expensive.

The seventh step involves design of a second mold having a non-manipulated or non-distorted surface 24. The non-distorted surface represents the desired final configuration of the part. The second mold repositions the distorted part produced using the first mold. In addition, the second mold restrains the part reinforcement or substrate by being a negative reproduction of the second surface of the substrate. As with the first mold, the second mold can be designed using a CAD system, however, it is understood that the mold can be designed manually using conventional drafting tools and techniques.

Once the mold designs are complete, steps eight and nine involve producing the first mold 26 and the second mold 28. Typically, numerically controlled machines can be used to produce the first mold and the second mold. The numerically controlled machines can directly use the data created in the CAD system during the design steps to produce the molds. It is understood that the molds can also be produced manually using standard mold building techniques with the data generated by the CAD system as well, without departing from the scope and spirit of the invention. The molds can be constructed of any conventional mold materials such as aluminum, zinc, steel, electroplated metals such as nickel and copper, and polymer based materials such as silicone and epoxy, for example.

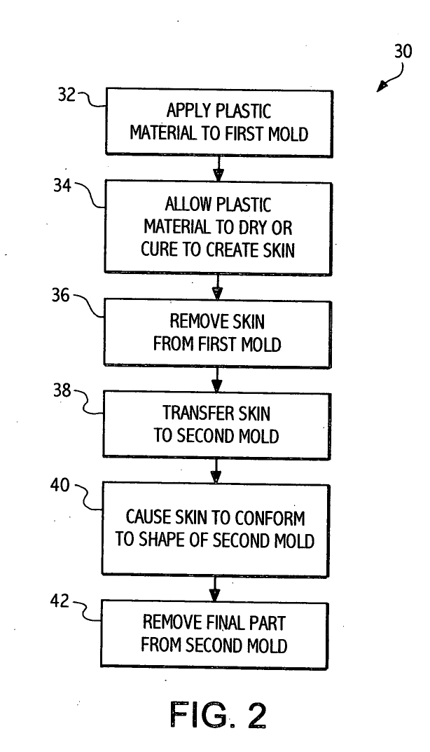

After the production of the molds is complete, the final step in the method, production of part 30 can be accomplished. FIG. 2 is a flow diagram of illustrating a production process using the mold produced according to the method described above and illustrated in FIG. 1. To produce the part, plastic is applied to the first mold 32. The parts can be produced by any conventional manufacturing process such as spraying polyurethane, slush molding, heat shaping, or rotocasting/rotational molding of thermoplastics such as PVC, TPU and TPO, for example. Thermoplastics may also be applied using Plasma Deposition.

Once the plastic has been applied, the plastic is allowed to dry, cool, or cure to create a skin 34. The skin is the plastic portion of the part. Once dried, cooled, or cured, the skin is removed from the first mold 36. The skin is then transferred to the second mold 38 having the desired final shape of the part. The skin is then caused to conform to the shape of the second mold 40. This is accomplished by any conventional method such as by application of vacuum or pressure to the skin surface, for example. Once the final shape of the part has been reached, the final part is removed from the second mold 42. The part is now ready for transfer to other manufacturing or assembly processes. It is understood that the ordering of the above steps is not critical, and that the order may be revised as desired.

The method steps as described eliminate steps of earlier manufacturing methods. By reducing the number of steps required for manufacturing the skins, cost is minimized and efficiency is maximized.

In accordance with the provisions of the patent statutes, the present invention has been described in what is considered to represent its preferred embodiment. However, it should be understood that the invention can be practiced otherwise than as specifically illustrated and described without departing from its spirit or scope.

1. A method of producing a shaped layer, the method comprising the steps of:
creating a model of a desired part;
creating a mathematical model of the part representing the model;
designing a first mold having a distorted surface using the mathematical model of the part, the distorted surface representing a visible surface of the part distorted to facilitate application of a plastic layer;
designing a second mold having a non-distorted surface representing a desired final shape of the part;
producing the first mold and the second mold; and
producing the part using the first mold and the second mold.

2. The method according to claim 1, wherein the step of producing the part further comprises the steps of:
applying a plastic to the first mold to create a skin;
removing the skin from the first mold;
transferring the skin to the second mold;
causing the skin to conform to the non-distorted surface of the second mold; and
removing the skin from the second mold.

3. The method according to claim 2, wherein the plastic is applied using gun spraying.

4. The method according to claim 3, wherein the plastic applied using gun spraying is polyurethane.

5. The method according to claim 2, wherein the plastic is applied using slush molding.

6. The method according to claim 2, wherein the plastic is applied using heat shaping.

7. The method according to claim 2, wherein the plastic is applied using rotational molding.

8. The method according to claim 2, wherein the plastic is applied using plasma deposition.

9. The method according to claim 1, wherein the distorted surface is designed by revising an angle of intersecting surfaces while maintaining a remaining geometry of an original configuration of the part.

10. The method according to claim 1, wherein the mathematical model is created using a computer.

11. A method of producing a shaped layer, the method comprising the steps of:
creating a model of a desired part;
taking dimensional measurements of the model and recording the measurements;
converting the measurements of the model to mathematical coordinates to represent the model in space;
creating a mathematical model of the part using the coordinates;
designing a first mold having a distorted surface using the mathematical model of the part, the distorted surface representing a visible surface of the part distorted to facilitate application of a plastic layer;
designing a second mold having a non-distorted surface representing a desired final shape of the part;
producing the first mold;
producing the second mold; and
producing the part.

12. The method according to claim 11, wherein the step of producing the part further comprises the steps of:
applying a plastic to the first mold to create a skin;
removing the skin from the first mold;
transferring the skin to the second mold;
causing the skin to conform to the non-distorted surface of the second mold; and
removing the skin from the second mold.

13. The method according to claim 12, wherein the plastic is applied using gun spraying.

14. The method according to claim 13, wherein the plastic applied using gun spraying is polyurethane.

15. The method according to claim 12, wherein the plastic is applied using slush molding.

16. The method according to claim 12, wherein the plastic is applied using heat shaping.

17. The method according to claim 12, wherein the plastic is applied using rotational molding.

18. A method of producing a shaped layer, the method comprising the steps of:
creating a three dimensional model of a desired part;
taking dimensional measurements of the model;
creating a mathematical model of the part using the measurements of the model;
designing and producing a first mold having a distorted surface using the mathematical model of the part, the distorted surface representing a visible surface of the part distorted to facilitate application of a plastic layer;
designing and producing a second mold having a non-distorted surface representing a desired final shape of the part;
applying a plastic to the first mold to create a skin;
removing the skin from the first mold;
transferring the skin to the second mold;
causing the skin to conform to the non-distorted surface of the second mold; and
removing the skin from the second mold.

19. The method according to claim 18, wherein the plastic is applied using at least one of gun spraying, slush molding, heat shaping, rotational molding, and plasma deposition.

20. The method according to claim 18, wherein the plastic applied is at least one of polyurethane, PVC, TPU and TPO.
